(19) United States
(12) Patent Application Publication
(10) Pub. No.: US 2003/0059041 A1
(43) Pub. Date: Mar. 27, 2003

(54) Methods and apparatus for two-party generation of DSA signatures

(76) Inventors: Philip D. MacKenzie, Maplewood, NJ (US); Michael Kendrick Reiter, Pittsburgh, PA (US)

Correspondence Address: Ryan, Mason & Lewis, LLP, 90 Forest Avenue, Locust Valley, NY, 11560, US

(21) Appl. No.: 10/183,900

(22) Filed: Jun. 26, 2002

Related U.S. Application Data
(60) Provisional application No. 60/300,992, filed on Jun. 26, 2001.

(51) Int. Cl. H04L 9/00

(52) U.S. Cl. 380/28; 713/180

(57) ABSTRACT

Techniques are provided for sharing the DSA signature function, so that two parties can efficiently generate a DSA signature with respect to a given public key but neither can alone. In an illustrative embodiment, the invention provides a DSA signature protocol that allows a proof of security for concurrent execution in the random oracle model. The invention also allows a proof of security for sequential execution without random oracles.

### CROSS REFERENCE TO RELATED APPLICATION

This application claims priority to the U.S. provisional patent application identified as Serial No. 60/300,992 filed on Jun. 26, 2001, and entitled “Two-Party Generation of DSA Signatures,” the disclosure of which is incorporated by reference herein.

### FIELD OF THE INVENTION

The present invention relates to cryptography and, more particularly, to techniques for providing two-party generation of digital signature algorithm (DSA) signatures.

### BACKGROUND OF THE INVENTION

There have been several techniques proposed for shared generation of digital signature algorithm (DSA) signatures. Shared generation of DSA signatures falls into the broader category of threshold signatures, which falls into the even broader category of threshold cryptography.

In S. Langford, “Threshold DSS Signatures Without a Trusted Party,” CRYPTO '95 (LNCS 963), pages 397-409, 1995, the disclosure of which is incorporated by reference herein, threshold DSA schemes are presented that ensure unforgeability against one corrupt player out of n≧3; of t corrupt players out of n for arbitrary t<n under certain restrictions; and of t corrupt players out of n≧2t+1.

While the Langford approach ensures unforgeability against t corrupt players out of n for an arbitrary t<n, such a benefit is achieved by using a trusted center to precompute the ephemeral secret key k for each signature and to share k⁻¹ mod q and k⁻¹x mod q among the n parties. That is, this solution circumvents the primary difficulties of sharing DSA signatures (i.e., inverting a shared secret and multiplying shared secrets) by using a trusted center. In an attempt to minimize the significant drawbacks of a trusted center, Langford further proposed to replace the trusted center with three centers (that protect k⁻¹ and k⁻¹x from any one). However, the use of three centers precludes this solution from being used in two-party DSA signature generation.

In M. Cerecedo et al., “Efficient and Secure Multiparty Generation of Digital Signatures Based on Discrete Logarithms,” IEICE Trans. Fundamentals of Electronics Communications and Computer Sciences E76A(4):532-545, April 1993, and in R. Gennaro et al., “Robust Threshold DSS Signatures,” EUROCRYPT '96 (LNCS 1070), pages 354-371, 1996, the disclosures of which are incorporated by reference herein, threshold schemes are presented that prevent t corrupt players out of n≧2t+1 from forging, and thus require a majority of correct players. Both of these schemes further develop robust solutions, in which the t corrupted players cannot interfere with the other n−t signing a message, provided that stronger conditions on n and t are met (at least n≧3t+1). However, robustness is not necessarily a goal of two-party DSA signature generation.

Thus, there exists a need for techniques which overcome the drawbacks associated with the approaches described above and which thereby provide more efficient protocols for performing two-party generation of DSA signatures.

### SUMMARY OF THE INVENTION

The present invention provides techniques for sharing the DSA signature function, so that two parties can efficiently generate a DSA signature with respect to a given public key but neither can alone.

For example, in one aspect of the invention, a method for use in a device associated with a first party for performing a signature operation on a message substantially based on the digital signature algorithm (DSA) comprises the following steps. In the first party device, a first component (e.g., ephemeral public key r) associated with the signature operation is generated based on assistance from a device associated with a second party. Then, in the first party device, a second component (e.g., signature component s) associated with the signature operation is generated based on further assistance from the second party device. A form of the first component and the second component are output as a result of the DSA signature operation.

Further, the above generating steps may preferably comprise an exchange of information between the first party device and the second party device whereby at least a portion of the information is encrypted using an encryption technique such that one party may encrypt information using its own public key and whereby another party can not read the information but can use the information to perform an operation (e.g., the encryption technique has a homomorphic property).

Generation of the first component of the signature operation, from the perspective of the first party device, may comprise: (i) computing in the first party device a first portion of an ephemeral private key associated with the signature operation; (ii) generating information representing an encryption of a form of the first portion of the ephemeral private key and a form of a first share of a private key shared by the first party device and the second party device; (iii) transmitting at least the encrypted information to the second party device; and (iv) computing the first component based on the first portion of the ephemeral private key and on data received from the second party device.

Generation of the second component of the signature operation, from the perspective of the first party device, may comprise recovering the second component from information received from the second party device, the information representing a function of the message, the first component, the first portion of the ephemeral private key, the first share of the shared private key, a second portion of the ephemeral private key, and a second share of the shared private key.

Still further, the first party device and the second party device may preferably multiplicatively share a private key. Also, the generating steps may further comprise generation and exchange of proofs between the first party device and the second party device that serve to verify operations performed by each party. The proofs may preferably be zero-knowledge proofs.

As will be illustrated herein, the invention may provide a DSA signature protocol that allows a proof of security for concurrent execution in the random oracle model. However, it is to be appreciated that the invention allows for embodiments with other models. By way of example only, the invention allows a proof of security for sequential execution without random oracles.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating a signature protocol in accordance with an embodiment of the present invention;

FIG. 2 is a diagram illustrating a construction of a proof for use with a signature protocol in accordance with an embodiment of the present invention;

FIG. 3 is a diagram illustrating a verification of a proof associated with a signature protocol in accordance with an embodiment of the present invention;

FIG. 4 is a diagram illustrating a construction of a proof for use with a signature protocol in accordance with an embodiment of the present invention;

FIG. 5 is a diagram illustrating a verification of a proof associated with a signature protocol in accordance with an embodiment of the present invention; and

FIG. 6 is a block diagram illustrating a generalized hardware architecture of a data network and computer systems suitable for implementing one or more of the methodologies according to the present invention.

### DETAILED DESCRIPTION OF PREFERRED EMBODIMENTS

The following description will illustrate the invention in the context of an illustrative distributed environment. However, it should be understood that the invention is not limited to such an environment. Rather, the invention is instead more generally applicable to any environment where it is desirable to share a DSA signature function, so that two parties can efficiently generate a DSA signature with respect to a given public key but neither can alone.

By way of example and without limitation, it is to be understood that a “device,” as used herein, may include any type of computing system, e.g., a personal computer (including desktops and laptops), a personal digital assistant (PDA), a smartcard, a cellular phone, a server, a hardware token, a software program, etc. However, it is to be understood that the protocols of the invention may be implemented between any two parties or entities using one or more of such devices.

As will be explained in detail below, the present invention provides an efficient and provably secure protocol by which two parties, respectively designated herein as “alice” (or a first party) and “bob” (or a second party), each holding a share of a DSA private key, can (and must) interact to generate a DSA signature on a given message with respect to the corresponding public key. It is to be appreciated that the general concepts and definitions associated with DSA signatures are well known in the field of cryptography. By way of example, U.S. Pat. No. 5,231,668 issued to D. W. Kravitz on Jul. 27, 1993 and entitled “Digital Signature Algorithm,” the disclosure of which is incorporated by reference herein, describes details on DSA signatures and associated keys.

As is known, shared generation of DSA signatures tends to be more complicated than shared generation of many other types of ElGamal-based signatures (as described in T. ElGamal, “A Public Key Cryptosystem and a Signature Scheme Based on Discrete Logarithms,” IEEE Transactions on Information Theory, 31:469-472, 1985, the disclosure of which is incorporated by reference herein) because: (i) a shared secret must be inverted; and (ii) a multiplication must be performed on two shared secrets. One can see this difference by comparing a Harn signature (as described in L. Harn, “Group Oriented (t,n) Threshold Digital Signature Scheme and Digital Multisignature,” IEEE Proc. Comput. Digit. Tech. 141(5):307-313, 1994, the disclosure of which is incorporated by reference herein) with a DSA signature, say over parameters <g, p, q>, with public/secret key pair <y(=g^{x} mod p), x> and ephemeral public/secret key pair <r(=g^{k} mod p), k>. In a Harn signature, one computes:

s←x(hash(m))−kr mod q,

and returns a signature <r,s>, while for a DSA signature, one computes:

s←k¹(hash(m)+xr)mod q,

and returns a signature <r mod q, s>. Obviously, to compute the DSA signature the ephemeral secret key must be inverted, and the resulting secret value must be multiplied by the secret key. It is to be understood that an “ephemeral” value (e.g., public or private key) as used herein refers to a value that is computed and/or used for the particular signature operation performed on the message at hand (e.g., a one time value). For security, all of these secret values must be shared, and thus inversion and multiplication on shared secrets must be performed. Thus, existing protocols to perform these operations have tended to be much more complicated than protocols for adding shared secrets.

However, the invention provides efficient and provably secure protocols for two-party DSA signature generation. As building blocks, the invention uses a public key encryption scheme with certain useful properties (for which several examples exist) and efficient special-purpose zero-knowledge proofs. The assumptions under which these building blocks are secure are the assumptions required for security of the inventive protocol. For example, by instantiating the inventive protocol with particular constructions, a protocol is achieved that is provably secure under the decision composite residuosity assumption or DCRA (as described in P. Paillier, “Public-Key Cryptosystems Based on Composite Degree Residuosity Classes,” EUROCRYPT '99 (LNCS 1592), pages 223-238, 1999, the disclosure of which is incorporated by reference herein) and the strong RSA assumption (as described in N. Barić et al., “Collision-Free Accumulators and Fail-stop Signature Schemes Without Trees,” EUROCRYPT '96 (LNCS 1233), pages 480-494, 1997, the disclosure of which is incorporated by reference herein) when executed sequentially, or one that is provably secure in the random oracle (as described in M. Bellare et al., “Random Oracles Are Practical: a Paradigm for Designing Efficient Protocols,” Proceedings of the 1st ACM Conference on Computer and Communications Security, pages 62-73, November 1993, the disclosure of which is incorporated by reference herein) under the DCRA and strong RSA assumption, even when arbitrarily many instances of the protocol are run concurrently. The former protocol requires eight messages, while the latter protocol requires only four messages.

Before explaining the protocols of the invention, we first introduce some definitions and notations which will be used in accordance with their explanations.

Security parameters. Let κ be the main cryptographic security parameter used for, e.g., hash functions and discrete log group orders; a reasonable value today may be κ=160. We will use κ′>κ as a secondary security parameter for public key modulus size; reasonable values today may be κ′=1024 or κ′=2048.

Signature schemes. A digital signature scheme is a triple (G_{sig}, S, V) of algorithms, the first two being probabilistic, and all running in expected polynomial time. G_{sig} takes as input 1^{κ′} and outputs a public key pair (pk, sk), i.e., (pk, sk)←G_{sig}(1^{κ′}). S takes a message m and a secret key sk as input and outputs a signature σ for m, i.e., σ←Sₛₖ(m). V takes a message m, a public key pk, and a candidate signature σ′ for m and returns the bit b=1 if σ′ is a valid signature for m, and otherwise returns the bit b=0. That is, b←Vₚₖ(m,σ′). Naturally, if σ←Sₛₖ(m), then Vₚₖ(m, σ)=1.

DSA. The digital signature algorithm (as described in the above-referenced U.S. Pat. No. 5,231,668) was proposed by National Institute of Standards and Technology (NIST) in April 1991, and in May 1994 was adopted as a standard digital signature scheme in the U.S. (referred to as the Digital Signature Standard or DSS). It is a variant of the ElGamal signature scheme, and is defined as follows, with κ=160, κ′ set to a multiple of 64 between 512 and 1024, inclusive, and hash function defined as SHA-1 (Federal Information Processing Standards (FIPS) Publication 180-1, Secure Hash Standard, the disclosure of which is incorporated by reference herein). Let “z←_{R}S” denote the assignment to z of an element of S selected uniformly at random. Let ≡_{q} denote equivalence modulo q.

G_{DSA}(1^{κ′}): Generate a κ-bit prime q and κ′-bit prime p such that q divides p-1. Then generate an element g of order q in Z*ₚ. The triple <g, p, q> is public. Finally generate x←_{R}Z_{q} and y←g^{x} mod p, and let <g, p ,q, x> and <g, p, q, y> be the secret and public keys, respectively.

S_{<g,p,q,x>}(m): Generate an ephemeral secret key k←_{R}Z_{q} and ephemeral public key r←g^{k}mod p. Compute s←k⁻¹(hash(m)+xr)mod q. Return <r mod q, s> as the signature of m.

V_{<g,p,q,y>}(m,<r,s>): Return 1 if 0<r<q, 0<s<q, and r≡_{q}(g^{hash(m)s}^{⁻¹} y^{rs}^{⁻¹} mod p) where s⁻¹ is computed modulo q. Otherwise, return 0.

Encryption schemes. An encryption scheme is a triple (G_{enc}, E, D) of algorithms, the first two being probabilistic, and all running in expected polynomial time. G_{enc} takes as input 1^{κ′} and outputs a public key pair (pk, sk), i.e., (pk, sk)←G_{enc}(1^{κ′}). E takes a public key pk and a message m as input and outputs an encryption c for m; we denote this c←Eₚₖ(M). D takes a ciphertext c and a secret key sk and returns either a message m such that c is a valid encryption of m, if such an m exists, and otherwise returns ⊥.

The signature protocol of the invention preferably employs a semantically secure encryption scheme with a certain additive homomorphic property. For any public key pk output from the G_{enc} function, let Mₚₖ be the space of possible inputs to Eₚₖ, and Cₚₖ to be the space of possible outputs of Eₚₖ. Then, we require that there exist an efficient implementation of an additional function +ₚₖ: Cₚₖ×Cₚₖ→Cₚₖ such that (written as an infix operator):

m₁, m₂, m₁+m₂∈Mₚₖ [symbol] Dₛₖ(Eₚₖ(m₁)+ₚₖEₚₖ(m₂))=m₁+m₂ (1)

Examples of cryptosystems for which +ₚₖ exist (with Mₚₖ=[−v,v] for a certain value v) are described in D. Naccache et al., “A New Public-Key Cryptosystem,” EUROCRYPT '97 (LNCS 1233), pages 27-36, 1997, in T. Okamoto et al., “A New Public-key Cryptosystem, as Secure as Factoring,” EUROCRYPT '98 (LNCS 1403), pages 308-318, 1998], and in P. Paillier, “Public-Key Cryptosystems Based on Composite Degree Residuosity Classes,” EUROCRYPT '99 (LNCS 1592), pages 223-238, 1999, the disclosures of which are incorporated by reference herein. Further, the cryptosystem of J. Benaloh, “Dense Probabilistic Encryption,” Workshop on Selected Areas of Cryptography, pages 12-128, 1994, the disclosure of which is incorporated by reference herein, also has this additive homomorphic property, and thus could also be used in the inventive protocol. Of course, other cryptosystems that use such a property may be employed. It is to be noted that equation (1) further implies the existence of an efficient function xₚₖ: Cₚₖ×Mₚₖ→Cₚₖ such that:

m₁,m₂, m₁m₂∈Mₚₖ [symbol] Dₛₖ(Eₚₖ(m₁)×ₚₖm₂)=m₁m₂ (2)

In addition, in the protocol of the invention, a party may be required to generate a noninteractive zero knowledge proof of a certain predicate P involving decryptions of elements of Cₚₖ, among other things. We denote such a proof as zkp [P]. Below, it will be illustrated how these proofs can be accomplished if the Paillier cryptosystem is in use. However, it is to be understood that use of the Paillier cryptosystem is only exemplary and, thus, the cryptosystems cited above, as well as others with similar properties, could equally well be used with the inventive protocol.

System model. The system of the invention includes two parties, referred to as “alice” and “bob.” Communication between alice and bob occurs in sessions (or protocol runs), one per message that they sign together. Alice plays the role of session initiator in the protocol. We presume that each message is implicitly labeled with an identifier for the session to which it belongs. Multiple sessions can be executed concurrently.

The adversary in the protocol controls the network, inserting and manipulating communication as it chooses. In addition, it takes one of two forms: an alice-compromising adversary learns all private initialization information for alice. A bob-compromising adversary is defined similarly.

We note that a proof of security in this two-party system extends to a proof of security in an n-party system in a natural way, assuming the adversary decides which parties to compromise before any session begins. The basic idea is to guess for which pair of parties the adversary forges a signature, and focus the simulation proof on those two parties, running all other parties as in the real protocol. The only consequence is a factor of roughly n² lost in the reduction argument from the security of the signature scheme.

1. Signature Protocol

In this section, an illustrative embodiment of the inventive protocol, called S-DSA, by which alice and bob sign a message m is presented.

1.1 Initialization

For the signature protocol of the invention, we assume that the private key x is multiplicatively shared between alice and bob, i.e., that alice holds a random private value x₁∈Z_{q} and bob holds a random private value x₂∈Z_{q} such that x≡_{q}x₁x₂. We also assume that along with y, y₁=g^{x}^{₁} mod p and y₂=g^{x}^{₂} mod p are public. It is assumed that the initialization step is preferably performed by a trusted third party. However, it may be accomplished without a trusted third party.

We use a multiplicative sharing of x to achieve greater efficiency than using either polynomial sharing or additive sharing. With multiplicative sharing of keys, inversion and multiplication of shared keys becomes trivial, but addition of shared keys becomes more complicated. For DSA, however, this approach allows a much more efficient two-party protocol.

In addition to sharing x, the signature protocol of the invention assumes that alice holds the private key sk corresponding to a public encryption key pk, and that there is another public encryption key pk′ for which alice does not know the corresponding sk′. As above, it is assumed that these keys are generated by a trusted third party. Also, for the particular zero-knowledge proof constructions, the range of Mₚₖ is at least [−q⁸,q⁸] and the range of Mₚₖ is at least [−q⁶,q⁶].

1.2 Signing Protocol

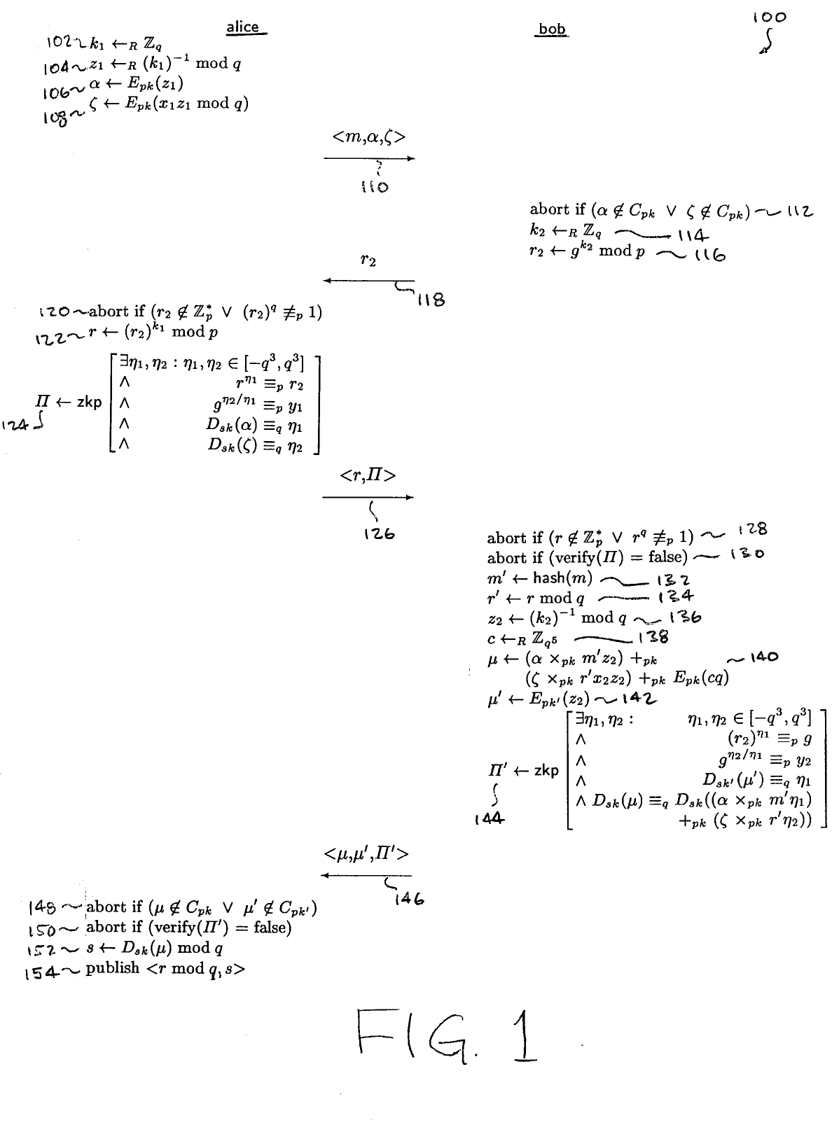

Referring now to FIG. 1, a flow diagram illustrates a signature protocol in accordance with an embodiment of the present invention. In particular, FIG. 1 illustratively depicts a protocol 100 by which alice and bob cooperate to generate signatures with respect to the public key <g, p, q, y>. As input to this protocol, alice receives the message m to be signed. However, bob receives no input (but receives m from alice in the first message).

Upon receiving m to sign, alice first computes (in step 102) its share k₁ of the ephemeral private key for this signature, computes z₁=(k₁)⁻¹ mod q (in step 104), and encrypts both z₁ (in step 106) and x₁z₁ mod q (in step 108) under pk. Alice's first message to bob (in step 110) comprises m and these ciphertexts, α and ζ.

Bob performs (in step 112) some simple consistency checks on α and ζ (though he cannot decrypt them, since he does not have sk), generates his share k₂ of the ephemeral private key (in step 114), and generates his share r₂=g^{k}^{₂} mod p of the ephemeral public key (in step 116). Bob's message to alice (in step 118) comprises r₂. This is the second message of the protocol.

Once alice has received r₂ from bob and performed (in step 120) simple consistency checks on it (e.g., to determine it has order q modulo Z*ₚ), she is able to compute the ephemeral public key r=(r₂)^{k}^{₁} mod p (in step 122). Alice also generates a noninteractive zero-knowledge proof II (in step 124) proving that there are values η₁(=z₁) and η₂(=x₁z₁ mod q) that are consistent with r, r₂, y₁, α and ζ and that are in the range [−q³,q³]. This last fact is necessary so that bob's subsequent formation of (a ciphertext of) s does not leak information about his private values. In the third message of the protocol, alice sends to bob (in step 126) the ephemeral public key r and the proof II.

Upon receiving <r, II>, bob performs additional consistency checks (in step 128) on r and verifies II (step 130). If these pass, then Bob computes m′ (in step 132), r′ (in step 134), z₂ (in step 136) and c (in step 138). Then, bob proceeds to compute a ciphertext μ of the value s (modulo q) for the signature (in step 140), using the ciphertexts α and ζ received in the first message from alice, the values (m), z₂=(k₂)⁻¹ mod q, r mod q, and x₂, and the special xₚₖ and +ₚₖ operators of the encryption scheme. In addition, bob uses +ₚₖ to “blind” the plaintext value with a random, large multiple of q. So, when alice later decrypts μ, she statistically gains no information about bob's private values. In addition to generating μ, bob computes μ′→E_{pk′}(z₂) (in step 142) and a noninteractive zero-knowledge proof II′ (in step 144) proving that there are values η₁(=z₂) and η₂(=x₂Z₂ mod p) consistent with r₂, y₂, μ and μ′, and that are in the range [−q³, q³]. In the fourth message of the protocol, alice sends to bob (in step 146) μ, μ′ and proof II′.

After receiving and checking these values (in steps 148 and 150) alice recovers s from μ (in step 152) to complete the signature, which is then published (in step 154).

The noninteractive zero-knowledge proofs II and II′ are assumed to satisfy the completeness, soundness, and zero-knowledge properties as defined in M. Blum et al., “Noninteractive Zero-Knowledge,” SIAM Journal of Computing 20(6):1084-1118, 1991, and in M. Naor et al., “Public-Key Cryptosystems Provably Secure Against Chosen Ciphertext Attacks,” Proceedings of the 22nd ACM Symposium on Theory of Computing, pages 427-437, 1990, the disclosures of which are incorporated by reference herein, except using a public random hash function (i.e., a random oracle) instead of a public random string.

In particular, we assume that: (1) these proofs have negligible simulation error probability, and in fact a simulator exists that generates a proof that is statistically indistinguishable from a proof generated by the real prover; and (2) these proofs have negligible soundness error probability, i.e., the probability that a prover could generate a proof for a false statement is negligible. The implementations of II and II′ in Section 2 enforce these properties under reasonable assumptions.

It is to be appreciated that to instantiate the signature protocol of the invention without random oracles, II and II′ would become interactive zero-knowledge protocols. Four-move protocols for II and II′ may be constructed. Also, by overlapping some messages, one can reduce the total number of moves in this instantiation of the S-DSA protocol to eight.

When the zero-knowledge proofs are implemented using random oracles, we can show that the protocol is secure even when multiple instances are executed concurrently. A key technical aspect is that we only require proofs of language membership, which can be implemented using random oracles without requiring rewinding in the simulation proof. In particular, we avoid the need for any proofs of knowledge that would require rewinding in knowledge extractors for the simulation proof, even if random oracles are used. The need for rewinding (and particularly, nested rewinding) causes many proofs of security to fail in the concurrent setting.

2. Proofs II and II′

In this section, we provide an example of how alice and bob can efficiently construct and verify the noninteractive zero-knowledge proofs II and II′. The form of these proofs naturally depends on the encryption scheme (G_{enc}, E, D), and the particular encryption scheme for which we detail II and II′ here is that described in the above-referenced P. Paillier, “Public-Key Cryptosystems Based on Composite Degree Residuosity Classes,” EUROCRYPT '99 (LNCS 1592), pages 223-238,1999. We reiterate, however, that use of Paillieris merely exemplary, and similar proofs II and II′ can be constructed with other cryptosystems satisfying the required properties described above.

It is to be understood that, in the remainder of Section 2, use of certain variables does not necessarily correspond to the same use above. Thus, certain variables may have been replaced or reused for different purposes. Nonetheless, from the description to follow, one skilled in the art will be able understand and appreciate these exemplary proofs.

2.1 The Paillier Cryptosystem

A specific example of a cryptosystem that has the homomorphic properties required for our protocol is the first cryptosystem presented in the above-referenced P. Paillier, “Public-Key Cryptosystems Based on Composite Degree Residuosity Classes,” EUROCRYPT '99 (LNCS 1592), pages 223-238, 1999. It uses the facts that w^{λ(N)}≡_{N}1 and w^{Nλ(N)}≡_{N}_{²}1 for any w∈ Z*_{N}_{²}, where λ(N) is the Carmichael function of N. Let L be a function that takes input elements from the set {u<N²|u≡1 mod N} and returns

$$L ( u ) = \frac{u - 1}{N} .$$

We then define the Paillier encryption scheme (G_{Pai}, E, D) as follows. This definition differs from that in the above-referenced P. Paillier article only in that we define the message space Mₚₖ for public key pk=<N, g> as M_{<N,g>}=[−(N−1)/2, (N−1)/2] (versus Z_{N} in the P. Paillier article).

G_{Pai}(1^{κ′}): Choose κ′/2-bit primes p, q, set N=pq, and choose a random element g∈Z*_{N}_{²} such that gcd (L(g^{λ(N)} mod N²), N)=1. Return the public key <N, g> and the private key <N, g, λ(N)>.

E_{<N, g>}(m): Select a random x∈Z*_{N} and return c=g^{m}x^{N} mod N².

D_{<N,g,λ(N)>}(c): Compute

$$m = \frac{L ( {c}^{λ ( N )} mod {N}^{2} )}{L ( {g}^{λ ( N )} mod {N}^{2} )}$$

mod N. Return m if m≦(N−1)/2, and otherwise return m−N.

c₁+_{<N, g>}c₂: Return c₁c₂ mod N².

c×_{<N, g>}c₂: Return c^{m} mod N².

Paillier shows that both c^{λ(N)} mod N² and g^{λ(N)} mod N² are elements of the form (1+N)^{d} ≡_{N}²1+dN, and thus the L function can be easily computed for decryption. The security of this cryptosystem relies on the Decision Composite Residuosity Assumption or DCRA.

2.2 Proof II

In this section, we show how to efficiently implement the proof II in the signature protocol of the invention when the Paillier cryptosystem is used. II′ is detailed below in Section 2.3. Both proofs rely on the following assumption.

Strong RSA Assumption. Given an RSA modulus generator G_{RSA} that takes as input 1^{κ′} and produces a value N that is the product of two random primes of length κ′/2, the Strong RSA assumption states that for any probabilistic polynomial-time attacker A:

Pr[N→G_{RSA}(1^{κ′);}y→_{R}Z*_{N};(x, e)→A(N, y):(e≧3)Λ(y≡_{N}x^{e})]

is negligible.

In our proofs, it is assumed that there are public values Ñ, h₁ and h₂. Soundness requires that Ñ be an RSA modulus that is the product of two strong primes and for which the factorization is unknown to the prover, and that the discrete logs of h₁ and h₂ relative to each other modulo Ñ are unknown to the prover. Zero knowledge requires that discrete logs of h₁ and h₂ relative to each other modulo Ñ exist (i.e., that h₁ and h₂ generate the same group). As in Section 1.1 above, here we assume that these parameters are distributed to alice and bob by a trusted third party. However, this assumption may be eliminated.

Now consider the proof II. Let p and q be as in a DSA public key, pk=<N, g> be a Paillier public key, and sk=<N, g, λ(N)> be the corresponding private key, where N>q⁶. For public values c, d, w₁, w₂, m₁, m₂, we construct a zero-knowledge proof II of:

$$P = [ \begin{matrix}{∃}_{{x}_{1} , {x}_{2}} \text{:} & {x}_{1} , {x}_{2} ∈ [ - {q}^{3} , {q}^{3} ] \\ ⋀ & {c}^{{x}_{1}} {≡}_{p} {w}_{1} \\ ⋀ & {d}^{{x}_{2} / {x}_{1}} {≡}_{p} {w}_{2} \\ ⋀ & {D}_{sk} ( {m}_{1} ) = {x}_{1} \\ ⋀ & {D}_{sk} ( {m}_{2} ) = {x}_{2}\end{matrix} ]$$

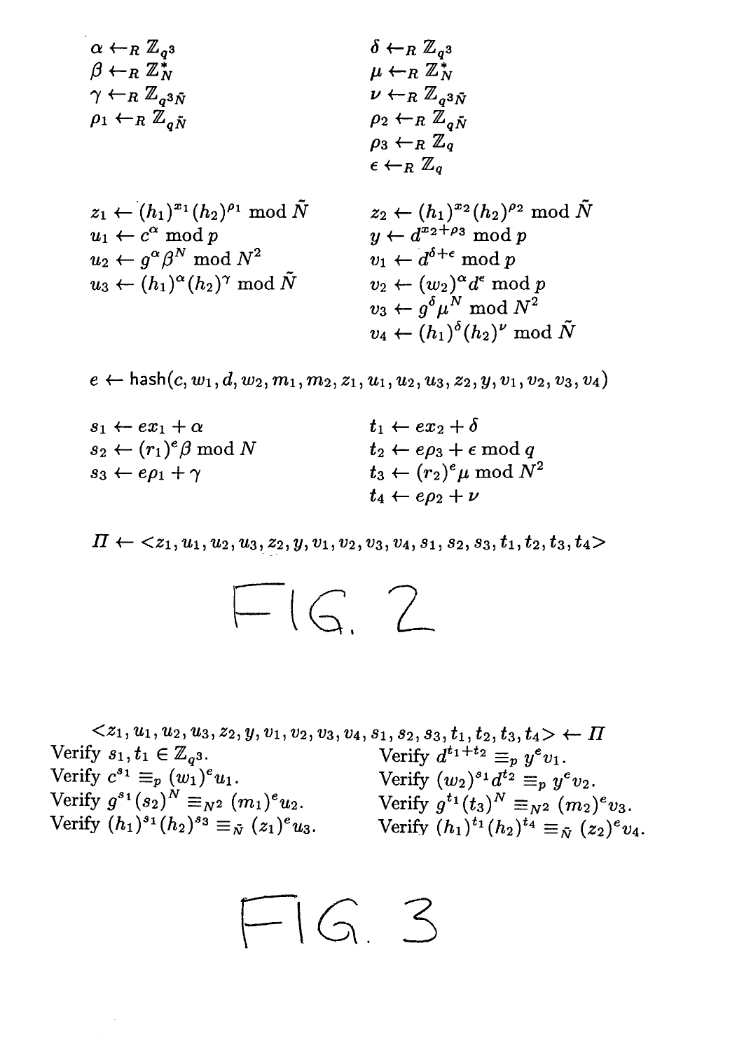

The proof is constructed in FIG. 2, and its verification procedure is given in FIG. 3. We assume that c, d, w₁, w₂∈Z*ₚ and are of order q, and that m₁, m₂∈Z*_{N}_{²}. The prover should verify this if necessary, and abort if not true. We assume the prover knows x₁, x₂∈Z_{q} and r₁, r₂∈Z*_{N} such that c^{x}^{₁}≡ₚw₁, d^{x}^{₂}^{/x}^{₁}≡ₚw₂, m₁≡_{N}_{²}g^{x}^{₁}(r₁)^{N} and m₂≡_{N}_{²}g^{x}(r₂)^{N}. The prover need not know sk, though a malicious prover might. If necessary, the verifier should verify that c, d, w₁, w₂∈Z*ₚ and are of order q, and that m₁, m₂∈Z*_{N}_{²}.

Intuitively, the proof works as follows. Commitments z₁, and z₂ are made to x₁, and x₂ over the RSA modulus Ñ, and these are proven to fall in the desired range using proofs as in E. Fujisaki et al., “Statistical Zero-knowledge Protocols to Prove Modular Polynomial Relations,” CRYPTO '97 (LNCS 1294), pages 16-30, 1997, the disclosure of which is incorporated by reference herein. Simultaneously, it is shown that the commitment z₁ corresponds to the decryption of m₁ and the discrete log of w₁. Also simultaneously, it is shown that the commitment z₂ corresponds to the decryption of m₂, and that the discrete log of w₂ is the quotient of the two commitments. The proof is shown in two columns, the left column used to prove the desired properties of x₁, w₁, and m₁ and the right column used to prove the desired properties of x₂, w₂ and m₂. It can also be stated and proven that II is a noninteractive zero-knowledge proof of P.

2.3 Proof II′

Now we look at the proof II′. Let p and q be as in a DSA public key, pk=<N, g> and sk=<N, g, λ(N)> be a Paillier key pair with N>q⁸, and pk′=<N′, g′> and sk′−<N′, g′, λ(N′)> be a Paillier key pair with N′>q⁶. For values c, d, w₁, w₂, m₁, m₂, m₃, m₄ such that for some n₁, n₂∈[−q⁴, q⁴], Dₛₖ(m₃)=n₁ and Dₛₖ(m₄)=n₂, we construct a zero-knowledge proof II′ of:

$${P}^{′} = [ \begin{matrix}{∃}_{{x}_{1}} {,}_{{x}_{2}} {,}_{{x}_{3}} \text{:} & {x}_{1} , {x}_{2} ∈ [ - {q}^{3} , {q}^{3} ] \\ ⋀ & {x}_{3} ∈ [ - {q}^{7} , {q}^{7} ] \\ ⋀ & {c}^{{x}_{1}} {≡}_{p} {w}_{1} \\ ⋀ & {d}^{{x}_{2} / {x}_{1}} {≡}_{p} {w}_{2} \\ ⋀ & {D}_{{sk}^{′}} ( {m}_{1} ) = {x}_{1} \\ ⋀ & {D}_{sk} ( {m}_{2} ) = {n}_{1} {x}_{1} + {n}_{2} {x}_{2} + {qx}_{3}\end{matrix} ]$$

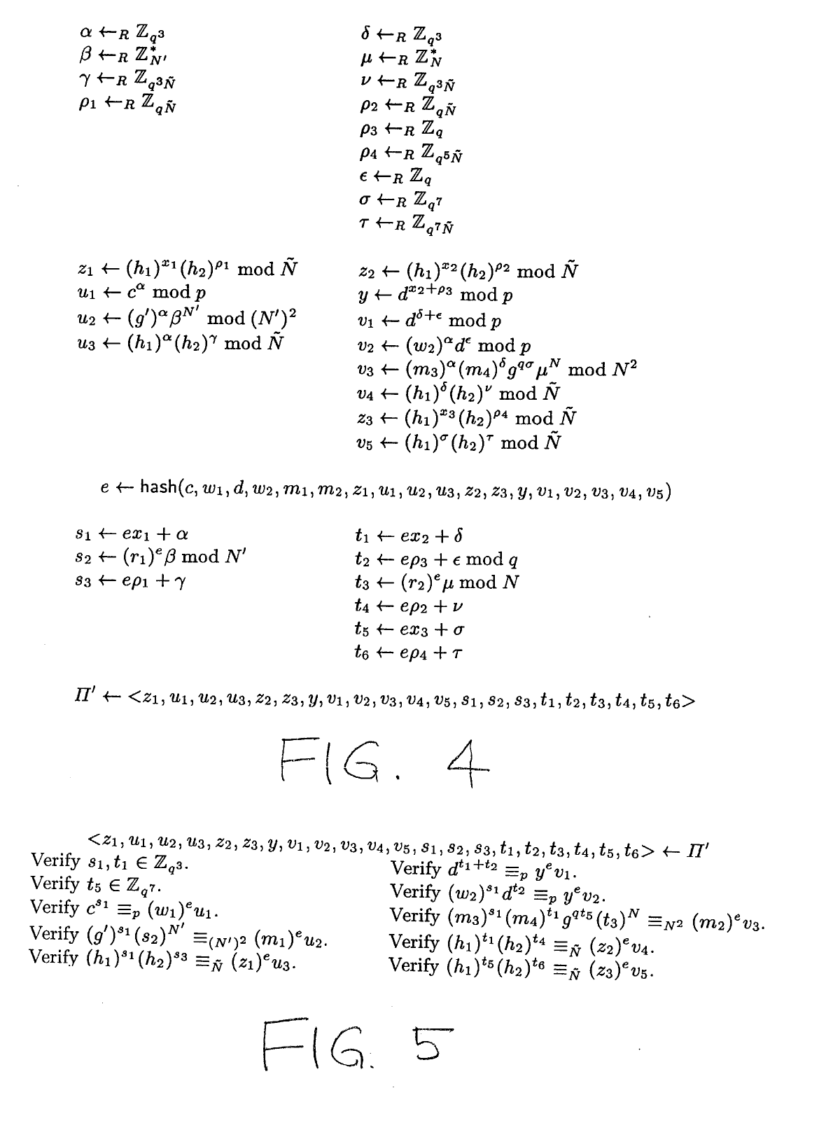

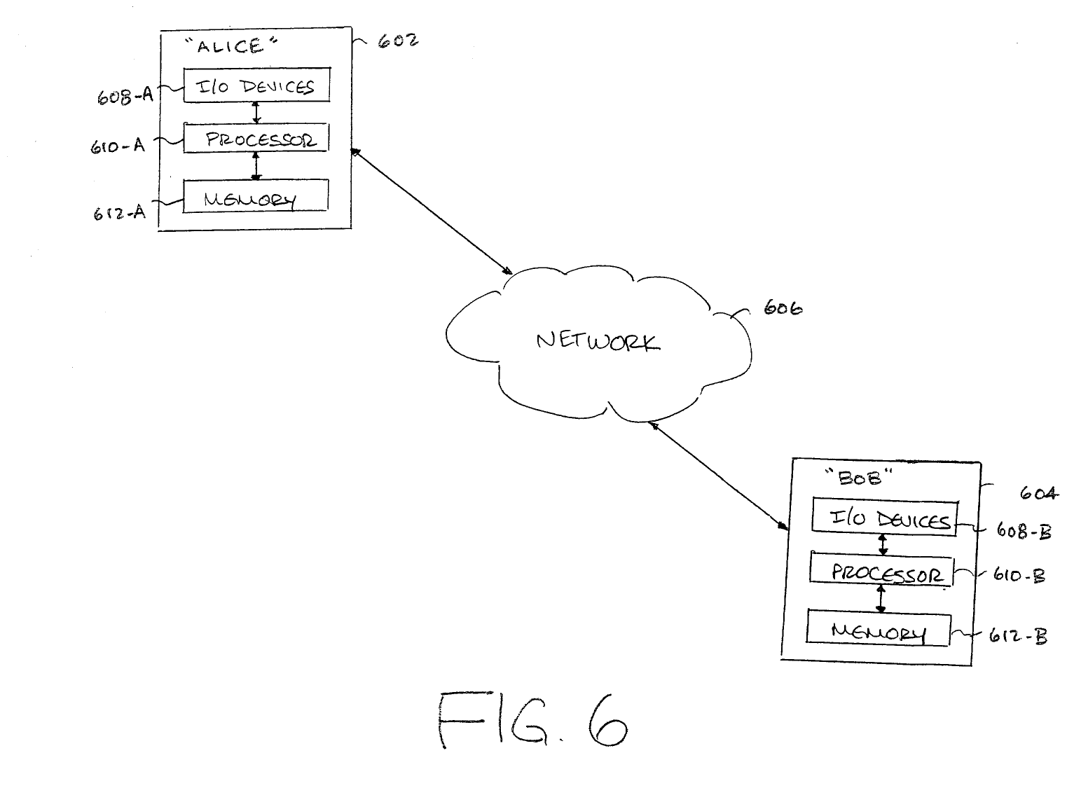

We note that P′ is stronger than what is needed as shown in FIG. 1. The proof is constructed in FIG. 4, and the verification procedure for it is given in FIG. 5. We assume that c, d, w₁, w₂∈Z*ₚ and are of order q, and that m₁∈Z*_{(N′)}_{²} and m₂∈Z*_{N}_{²}. The prover should verify this if necessary. We assume the prover knows x₁, x₂∈Z_{q, x}₃∈Z_{q}_{⁵}, and r₁, r₂∈Z*_{N}, such that c^{x}^{₁}≡ₚw₁, d^{x}^{₂}^{/x}^{₁}≡ₚw₂, m₁≡_{(N′)}²(g′)^{x}^{₁}(r₁)^{N′} and m₂≡N²(m₃)^{x}^{₁}(m₄)^{x}^{₂}g^{qx}^{₃}(r₂)^{N}. The prover need not know sk or sk′, though a malicious prover might know sk′. We assume the verifier knows n₁ and n₂. If necessary, the verifier should verify that c, d, w₁, W₂∈Z*ₚ and are of order q, and that m₁∈Z*_{(N′)}_{²} and m₂∈Z*_{N}_{²}. It can also be stated and proven that II′ is a noninteractive zero-knowledge proof of P′.

Referring now to FIG. 6, a block diagram illustrates a generalized hardware architecture of a distributed data network and computer systems suitable for implementing a two-party DSA signature protocol between two parties (e.g., “alice” and “bob”) according to the present invention. As shown, the first party (alice) employs a computer system 602 to participate in the protocol, while the second party (bob) employs a computer system 604 to participate in the protocol. The two computer systems 602 and 604 are coupled via a data network 606. The data network may be any data network across which the two parties desire to communicate, e.g., the Internet. However, the invention is not limited to a particular type of network.

The computer systems in FIG. 6 represent “devices,” as mentioned above. The devices may be, for example, personal computers (including desktops and laptops), personal digital assistants (PDA), smartcards, cellular phones, servers, hardware tokens, software programs, etc. However, the invention is not limited to any particular device.

As is readily apparent to one of ordinary skill in the art, the computer systems of FIG. 6 may be implemented as programmed computers operating under control of computer program code. The computer program code is stored in a computer readable medium (e.g., a memory) and the code is executed by a processor of the computer system. Given this disclosure of the invention, one skilled in the art can readily produce appropriate computer program code in order to implement the protocols described herein.

In any case, FIG. 6 generally illustrates an exemplary architecture for each computer system communicating over the network. As shown, the first party device comprises I/O devices 608-A, processor 610-A, and memory 612-A. The second party device comprises I/O devices 608-B, processor 610-B, and memory 612-B. It should be understood that the term “processor” as used herein is intended to include one or more processing devices, including a central processing unit (CPU) or other processing circuitry. Also, the term “memory” as used herein is intended to include memory associated with a processor or CPU, such as RAM, ROM; a fixed memory device (e.g., hard drive), or a removable memory device (e.g., diskette or CDROM). In addition, the term “I/O devices” as used herein is intended to include one or more input devices (e.g., keyboard, mouse) for inputting data to the processing unit, as well as one or more output devices (e.g., CRT display) for providing results associated with the processing unit.

Accordingly, software instructions or code for performing the protocols/methodologies of the invention, described herein, may be stored in one or more of the associated memory devices, e.g., ROM, fixed or removable memory, and, when ready to be utilized, loaded into RAM and executed by the CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

We claim:

1. A method for use in a device associated with a first party for performing a signature operation on a message substantially based on the digital signature algorithm (DSA), the method comprising the steps of:
generating in the first party device a first component associated with the signature operation based on assistance from a device associated with a second party;
generating in the first party device a second component associated with the signature operation based on further assistance from the second party device; and
outputting a form of the first component and the second component as a result of the DSA signature operation.

2. The method of claim 1, wherein the generating steps comprise an exchange of information between the first party device and the second party device whereby at least a portion of the information is encrypted using an encryption technique such that one party may encrypt information using its own public key and whereby another party can not read the information but can use the information to perform an operation.

3. The method of claim 1, wherein the generating steps comprise an exchange of information between the first party device and the second party device whereby at least a portion of the information is encrypted using an encryption technique having a homomorphic property.

4. The method of claim 1, wherein generation of the first component comprises:
computing in the first party device a first portion of an ephemeral private key associated with the signature operation;
generating information representing an encryption of a form of the first portion of the ephemeral private key and a form of a first share of a private key shared by the first party device and the second party device;
transmitting at least the encrypted information to the second party device; and
computing the first component based on the first portion of the ephemeral private key and on data received from the second party device.

5. The method of claim 1, wherein the first party device and the second party device multiplicatively share a private key.

6. The method of claim 4, wherein generation of the second component comprises recovering the second component from information received from the second party device, the information representing a function of the message, the first component, the first portion of the ephemeral private key, the first share of the shared private key, a second portion of the ephemeral private key, and a second share of the shared private key.

7. The method of claim 1, wherein the generating steps further comprise generation and exchange of proofs between the first party device and the second party device that serve to verify operations performed by each party.

8. The method of claim 7, wherein the proofs are zero-knowledge proofs.

9. A method for use in a device associated with a first party for assisting in the performance of a signature operation on a message substantially based on the digital signature algorithm (DSA), the method comprising the steps of:
providing assistance in the first party device for the generation of a first component associated with the DSA signature operation in accordance with a device associated with a second party; and
providing further assistance in the first party device for the generation of a second component associated with the DSA signature operation in accordance with the second party device.

10. The method of claim 9, wherein generation of the first component and the second component comprises an exchange of information between the first party device and the second party device whereby at least a portion of the information is encrypted using an encryption technique such that one party may encrypt information using its own public key and whereby another party can not read the information but can use the information to perform an operation.

11. The method of claim 9, wherein generation of the first component and the second component comprises an exchange of information between the first party device and the second party device whereby at least a portion of the information is encrypted using an encryption technique having a homomorphic property.

12. The method of claim 9, wherein assistance in generating the first component comprises:
responsive to receipt in the first party device of information computed in the second party device representing an encryption of a form of a first portion of an ephemeral private key associated with the signature operation and a form of a first share of a private key shared by the first party device and the second party device, computing a second portion of the ephemeral private key; and
transmitting the second portion of the ephemeral private key to the second party device.

13. The method of claim 12, wherein assistance in generating the second component comprises, responsive to receipt in the first party device of information computed in the second party device, computing in the first party device a form of the second component for subsequent recovery in the second party device.

14. The method of claim 9, wherein the first party device and the second party device multiplicatively share a private key.

15. The method of claim 9, further comprising the steps of generating and exchanging proofs between the first party device and the second party device that serve to verify operations performed by each party.

16. The method of claim 15, wherein the proofs are zero-knowledge proofs.

17. Apparatus for use in a device associated with a first party for performing a signature operation on a message substantially based on the digital signature algorithm (DSA), the apparatus comprising:
at least one processor operable to: (i) generate in the first party device a first component associated with the signature operation based on assistance from a device associated with a second party; (ii) generate in the first party device a second component associated with the signature operation based on further assistance from the second party device; and (iii) output a form of the first component and the second component as a result of the DSA signature operation; and
memory, coupled to the at least one processor, for storing at least a portion of results associated with one or more operations performed by the processor.

18. Apparatus for use in a device associated with a first party for assisting in the performance of a signature operation on a message substantially based on the digital signature algorithm (DSA), the apparatus comprising:
at least one processor operable to: (i) provide assistance in the first party device for the generation of a first component associated with the DSA signature operation in accordance with a device associated with a second party; and (ii) provide further assistance in the first party device for the generation of a second component associated with the DSA signature operation in accordance with the second party device; and
memory, coupled to the at least one processor, for storing at least a portion of results associated with one or more operations performed by the processor.
